(19) United States
(12) Patent Application Publication
(10) Pub. No.: US 2023/0247062 A1
(43) Pub. Date: Aug. 3, 2023

(54) SYSTEMS AND METHODS FOR AUTOMATED NEUTRALIZATION OF IDS DETECTED MALWARE THREATS

(71) Applicant: Raytheon Company, Waltham, MA (US)

(72) Inventors: Joseph Blankenship, Greenville, SC (US); Omar Brown, Greenville, SC (US); Ralph Lambert, Indialantic, FL (US)

(73) Assignee: Raytheon Company, Waltham, MA (US)

(21) Appl. No.: 18/102,912

(22) Filed: Jan. 30, 2023

Related U.S. Application Data
(60) Provisional application No. 63/305,918, filed on Feb. 2, 2022.

(51) Int. Cl. H04L 9/40

(52) U.S. Cl. CPC H04L 63/205; H04L 63/145

(57) ABSTRACT

A malware neutralization system for a computer network includes an intrusion detection system (IDS) in data communications with the computer network. The IDS is arranged to: i) detect malware communications between a malware command and control (C2) server and a malware client on a computer connected to the computer network and ii) send a malware alert to a malware response server. The malware response server is in communications with the computer network and arranged to: i) receive the first malware alert, ii) determine the type of malware threat based on the first malware alert, iii) intercept one or more malware messages from the malware client that are directed to the malware C2 server, iv) instantiate an appropriate malware response module, and v) use the loaded response module to send one or more malware response messages to the malware client to disrupt an operation of the malware client.

### REFERENCE TO RELATED APPLICATIONS

This application claims priority to and the benefit of U.S. Provisional Patent Application No. 63/305,918, filed on Feb. 2, 2022, entitled “Systems and Methods for Automated Neutralization of IDS Detected Malware Threats,” the entire contents of which are incorporated herein by reference.

### TECHNICAL FIELD

This application relates generally to malicious software protection systems and, more particularly, to malware neutralization techniques.

### BACKGROUND

Malware, including botnets, allow malicious actors to remotely access systems and resources on a victim's computer or data network by communicating with a Command and Control (C2) Server. Malware (i.e., malicious software) includes any software designed to cause disruption to a computer, server, client, or computer network, leak private information, gain unauthorized access to information or systems, deprive users access to information, or that interfere with a user's computer security and privacy. Various types of malware exist, such as computer viruses, worms, Trojan horses, ransomware, spyware, adware, rogue software, wiper, and scareware.

Protection and recovery strategies against malware can vary according to the type of malware. Typical protection techniques include installing antivirus software, firewalls, applying regular patches to reduce attack vectors, securing networks from intrusion, having regular backups and isolating infected systems. Certain types of malware are now being designed to evade antivirus software detection. Commercial products are available for passive network intrusion detection and defensive end-point security, but no existing products provide for the automated neutralization of malware, without requiring end point security software running on the victim node.

The usual solution for actively addressing malware threats is by using an endpoint security product, such as subscription-based anti-virus products (e.g., Symantec®, McAfee®, Kaspersky®, etc). These defensive products are reasonably effective for detecting and blocking malware activity on Windows and macOS end-user machines, but are less effective for protecting Linux workstations and servers. Furthermore, this requires that an endpoint actually has a properly configured and updated endpoint security product installed. In some heterogeneous networks, such as school campus networks, it may be difficult to enforce an endpoint security product policy. As a result, the likelihood of malware infection on a user's endpoint device is likely higher than on a homogenous corporate network.

Commercial Intrusion Detection Systems (IDS) are reasonably effective at detecting malware activity on the network, but as a passive tool, they do little more than notify an operator. The volume of IDS network activity notifications can be overwhelming, causing malware threats to be overlooked. Hence, an IDS provides only detection and notification, and does not provide any automated mechanism for isolating or removing the malware.

Thus, there is a need for more reliable, flexible, robust, and non-end-point approaches to neutralizing malware threats to computer networks and systems.

### SUMMARY

The application, in various implementations, addresses deficiencies associated with existing malware protection and/or recovery systems.

This application describes exemplary systems and methods that leverage one or more IDSs for detecting malicious network activity. When malicious network activity is observed by an IDS, an alert is sent by the IDS to a malware countermeasures server and/or response server. In some implementations, a “listener” abstraction layer within the response server is responsible for receiving alerts from an IDS and converting the alert to an internal format. The alert is then passed to the response server's response manager and/or module, which searches the response server's database of responses to determine if a response exists for a received alert signature. If a response is found, then the response server loads it from the countermeasures and/or response database and creates a “response thread.” If a response thread is already handling a matching threat, the new alert will be attached to the existing thread to be handled.

The response module and/or server intercepts all traffic between the malware host and/or malware client and malware C2 server. This allows the responses to modify the traffic and masquerade as the victim computer (or malware client on the victim's computer) or the malware C2 server. With this level of access, the response server neutralizes the malware threat by employing offensive cybersecurity techniques. The ability to employ offensive cyber techniques differentiates systems and methods described herein from existing solutions.

In one aspect, a malware neutralization system for a computer network includes a first intrusion detection system being in data communications with the computer network and arranged to: i) detect malware communications between a malware C2 server and a malware client on a first computer connected to the computer network and ii) send a first malware alert to a malware response server. The malware response server is also in communications with the computer network and arranged to: i) receive the first malware alert, ii) determine the type of malware threat based on the first malware alert, iii) load an appropriate malware response module, iv) intercept one or more malware messages from the malware client that are directed to the malware C2 server, and v) send one or more malware response messages to the malware client to disrupt an operation of the malware client.

The malware response module may masquerade as the malware C2 server to the malware client. The malware response module may masquerade as the C2 server to the malware client via one or more malware response messages. The one or more malware response messages may include a TCP reset command, a cryptographic key negotiation command, a cryptographic key negotiation message, and/or a shutdown command. The malware response module may compare the one or more malware messages from the malware client to a set of known malware messages in a malware database to determine the one or more malware response messages to be sent to the malware client. The system may include a second intrusion detection system in communications with the computer network and arranged to: i) detect malware communications between a malware C2 server and the malware client on the first computer connected to the computer network and ii) send a second malware alert to the malware response server.

In another aspect, a malware neutralization system for a computer network includes a first intrusion detection system being in data communications with the computer network and arranged to: i) detect malware communications between a malware C2 server and a first malware client on a first computer connected to the computer network and ii) send a first malware alert to a malware response server. The malware response server is also in communications with the computer network and arranged to: i) receive the first malware alert, ii) determine the type of malware threat based on the first malware alert, iii) load an appropriate malware response module, iv) intercept one or more first malware messages from the C2 server that are directed to the first malware client on the first computer, and v) send one or more first malware response messages to the malware C2 server to disrupt an operation of the malware C2 server.

The malware response module may masquerade as the first malware client and/or the first computer to the malware C2 server. The malware response module may masquerade as the first malware client and/or the first computer via the one or more first malware response messages. The one or more first malware response messages may include a TCP reset command, a cryptographic key negotiation command, a cryptographic key negotiation message, and/or a ZIP file. The response module may be further arranged to intercept one or more second malware messages from the first malware client that are directed to the malware C2 server and send one or more second malware response messages to the first malware client to disrupt an operation of the first malware client.

The malware response module may masquerade as the malware C2 server to the first malware client. The malware response module may masquerade as the C2 server to the malware client via the one or more second malware response messages. The one or more second malware response messages may include a TCP reset command, a cryptographic key negotiation command, a cryptographic key negotiation message, and/or a shutdown command. The malware response module may compare the one or more first malware messages from the C2 server to a set of known first malware messages in a malware database to determine the one or more first malware response messages to be sent to the malware C2 server. The system may include a second intrusion detection system in communications with the computer network and arranged to: i) detect malware communications between a malware C2 server and the first malware client on a first computer connected to the computer network and ii) send a second malware alert to the malware response server.

In another aspect, a method for neutralizing malware in a computer network includes: providing data communications between a first intrusion detection system and the computer network; detecting, via the first intrusion detection system, malware communications between a malware C2 server and a malware client on a first computer connected to the computer network; sending, from the first intrusion detection system, a malware alert to a malware response server;; receiving, at the malware response server, the malware alert; determining, at the malware response server. the type of malware threat based on the malware alert; loading an appropriate malware response module; providing data communications between the malware response module and the computer network; intercepting, by the malware response module, one or more malware messages from the malware client that are directed to the malware C2 server; and sending, from the malware response module, one or more malware response messages to the malware client to disrupt an operation of the malware client.

In a further aspect, a method for neutralizing malware in a computer network includes: providing data communications between a first intrusion detection system and the computer network; detecting, via the first intrusion detection system, malware communications between a malware C2 server and a malware client on a first computer connected to the computer network; sending, from the first intrusion detection system, a malware alert to a malware response server; receiving, at the malware response server, the malware alert; determining, at the malware response server, the type of malware threat based on the malware alert; loading an appropriate malware response module; providing data communications between the malware response module and the computer network; intercepting, by the malware response module, one or more malware messages from the C2 server that are directed to the malware client on the first computer; and sending, from the malware response module, one or more malware response messages to the malware C2 server to disrupt an operation of the malware C2 server.

In yet another aspect, a non-transient computer readable medium containing program instructions for causing a computer to implement malware neutralization within a computer network includes the method of: receiving, from an intrusion detection system, a malware alert; determining the type of malware threat based on the malware alert; intercepting one or more malware messages from a malware C2 server that are directed to a malware client on a first computer connected to the computer network; and sending one or more malware response messages to the malware C2 server to disrupt an operation of the malware C2 server.

In yet a further aspect, a non-transient computer readable medium containing program instructions for causing a computer to implement malware neutralization within a computer network includes the method of: receiving, from an intrusion detection system, a malware alert; determining the type of malware threat based on the malware alert; intercepting one or more malware messages from a malware client on a first computer connected to the computer network that are directed to a malware C2 server; and sending one or more malware response messages to the malware client to disrupt an operation of the malware client.

Any two or more of the features described in this specification, including in this summary section, may be combined to form implementations not specifically described in this specification.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram of an exemplary malware neutralization system within a computer network:

FIG. 2 shows a diagram of a computer system arranged to perform function associated with malware neutralization;

FIG. 3 shows a block diagram of a malware neutralization system; and

FIG. 4 shows a process for neutralizing malware in a computer network.

Like reference numerals in different figures indicate like elements.

### DETAILED DESCRIPTION

The application, in various implementations, addresses deficiencies associated with neutralizing malware threats to a computer network.

Various implementations include applying offensive techniques for active network defense. The systems and methods described herein use a novel approach of applying various offensive techniques against malware which may (1) prevent communication with a malware Command and Control (C2) server and (2) neutralize the malware by exploiting vulnerabilities found in the malware.

In some implementations, the systems and methods described herein leverage a commercial Intrusion Detection System (IDS) product for detecting malicious network activity. When malicious network activity is observed by the IDS, it sends an alert to a malware countermeasures server and/or response server. A “listener” abstraction layer within the response server is responsible for receiving alerts from the IDS and converting the alert to an internal format. The alert is then passed to the response server's response manager and/or module, which searches the response server's database of responses to determine if a response exists for our alert signature. If a response is found, then the response server loads it from the countermeasures and/or response database, and creates a “response thread”. If a response thread is already handling a matching threat, the new alert will be attached to the existing thread to be handled.

The response module loaded by the response server intercepts all traffic between the host and malware C2. This allows the responses to modify the traffic and masquerade as the victim computer (or malware client on the victim's computer) or the C2. With this level of access, the response server neutralizes the malware threat by employing offensive cybersecurity techniques. The ability to employ offensive cyber techniques differentiates systems and methods described herein from other commercial off the shelf solutions.

In some implementations, the response server responses leverage discoveries gleaned during vulnerability analysis of various malware exemplars to guide inventive offensive capabilities. For instance, with PowerShell Empire, analysis of its source code revealed that it was possible to force the renegotiation of a cryptographic key responsible for security communications between the malware client running on a victim's computer and its C2 server. In one implementation, a response module was implemented to exploit this vulnerability. The response module forces a key negotiation, capturing the new cryptographic keys. This allows the response module to decrypt the internal communications between the malware and C2 server, Additionally, the response module can properly masquerade as either the C2 or victim and can send commands. For the EmpireResponder demo, the response server loads a response module that masquerades as the malware C2 and sends the victim a properly crafted malware “shutdown” message. This effectively neutralizes the PowerShell Empire malware.

A similar technique was employed by the Metasploit Meterpreter responder. The responder and/or countermeasures module forces the Metasploit Meterpreter implant to renegotiate its Advanced Encryption Standard (AES) encryption key. With knowledge of the key, the response module can craft “authentic” commands. By crafting a spoofed C2 “shutdown” command and injecting it into the malware's communication channel, the response module can neutralize the second malware exemplar.

Another unique capability of the response module and/or server is the ability of a response module to offensively attack a malware's C2 server. Vulnerability analysis of the PowerShell Empire code, lead to the development of a novel counterattack against the C2. The malware C2 has a command that it uses to enable malware agents to register themselves when they first execute. However, the malware C2 server does not maintain a whitelist of agents that are allowed to register. Therefore, a response module counterattack is able to spam the C2 with false agent registrations. The hostile C2's database of agents then becomes polluted with junk registrations, which render the database useless. Additionally, the response module and/or server can upload small ZIP bombs to the C2. Upon receipt, the malware C2 decompresses the uploaded files, filling its hard drive. When the drive fills, it causes the malware C2 server to crash. At this point, the malware and malware C2 have been neutralized. Although a capability to counterattack the C2 segment may be of limited commercial value, it demonstrates the “art of the possible” and could have use cases in government settings, with organizations possessing the jurisdictional authority to launch counter-attacks against threat actors.

In some implementations, the response module can effectively interrupt malware from communicating with its C2 server by automatically sending transmission control protocol (TCP) Resets to both ends of the intercepted connection. This proves an effective way to rapidly “sinkhole” malware. This technique was demonstrated to work against a Metasploit Eternal Blue attack.

While certain exemplars were analyzed by a human, in some implementations, the systems and methods described herein enable automation of a vulnerability analysis using machine learning algorithms. Integrating the techniques described herein with other malware protection tools could allow for rapid auto analysis of malware samples, quickly driving the development of response modules. Additionally, this automated analysis could be used to drive automated, machine learning derived, malware responses to active threats.

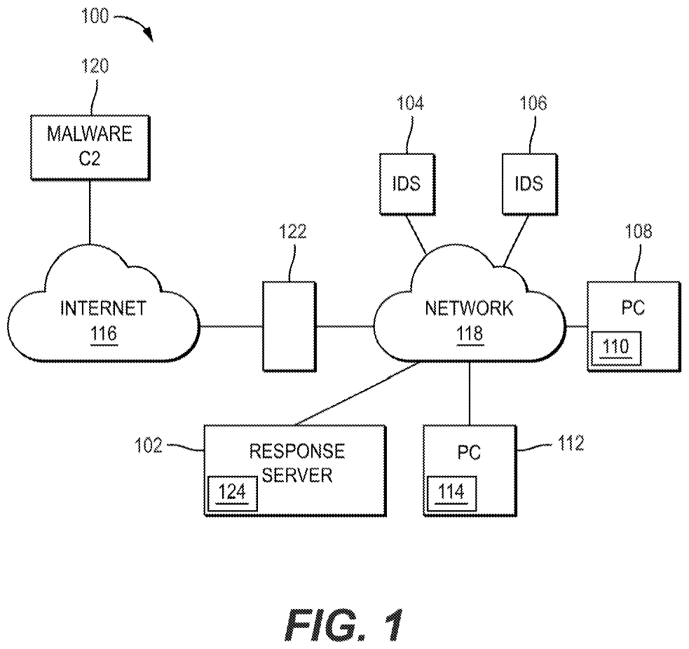

FIG. 1 is a block diagram of an exemplary malware neutralization system 100 within a computer network 118. The system 100 includes a malware response server 102, malware response module 124, an IDS 104, IDS 106, a computer 108, computer 112, and a gateway 122. The gateway 122 may include a firewall, router, and/or one or more servers that facilitate communications between the Internet 116 and the network 118. Network 118 may be a private network, an enterprise network, local area network (LAN), wide area network (WAN), and the like. FIG. 1 also shows a malware C2 server 120 connected to the Internet 116 and malware host and/or clients 110 and 114 residing in computers 108 and 112 respectively. Response server 102 may include a response module 124 and/or manager application. The response module 124 may also or alternatively be located in another device within network 118 such as gateway 122, IDS 104, IDS 106, computer 108, and/or computer 114. The response module 124 may include software, hardware, firmware, or a combination thereof.

Typically, malware C2 server 120 will establish communications with malware clients 110 and 114 that have been installed on computers 110 and 114. This will enable malware C2 server 120 to potentially control operations of computers 108 and 112, gather information stored on computers 108 and 112, or monitor activities of users of computers 108 and 112, inhibit operations of computers 108 and 112, or monitor activities within network 118. In one implementation, IDS 104 and/or IDS 106 are arranged to: i) detect malware communications between malware C2 server 120 and malware client 110 on a computer 108 or malware client 114 on computer 112 and ii) send a first malware alert to malware response module 124 in response server 102. The malware response module 124 may be arranged to: i) receive the first malware alert, ii) determine the type of malware threat based on the first malware alert, iii) intercept one or more malware messages from the malware client 110 that are directed to the malware C2 server 120. and iv) send one or more malware response messages to the malware client 110 to disrupt an operation of the malware client 110. The response module 124 of server 102 may perform similar actions with respect to malware client 114 of computer 112.

The malware response module 124 may masquerade as the malware C2 server 120 to the malware client 110. The malware response module 124 may masquerade as the C2 server 120 to the malware client 110 via one or more malware response messages. The one or more malware response messages may include, without limitation, a TCP reset command, a cryptographic key negotiation command, a cryptographic key negotiation message, and/or a shutdown command. The malware response module 124 may compare one or more malware messages from the malware client 110 to a set of known malware messages in a malware database to determine the one or more malware response messages to be sent to the malware client 110. IDS 106 may be arranged to: i) detect malware communications between a malware C2 server 120 and the malware client 110 on computer 108 or malware client 114 on computer 112 and ii) send a second malware alert to the malware response module 124 that will be acted on accordingly by the malware response module 124.

In addition to or separately, IDS 104 may be arranged to: i) detect malware communications between malware C2 server 120 and malware client 110 on computer 108 and/or malware client 114 on computer 112 and ii) send a malware alert to the malware response module 124 in server 102. The malware response module 124 may be arranged to: i) receive the first malware alert, ii) determine the type of malware threat based on the first malware alert, iii) intercept one or more malware messages from the malware C2 server 120 that are directed to malware client 110 on computer 108 or malware client 114 on computer 112 and iv) send one or more malware response messages to the malware C2 server 120 to disrupt an operation of the malware C2 server 120.

The malware response module 124 may masquerade as a malware client 110 or 114 and/or as computer 108 or 112 to the malware C2 server 120. The malware response module 120 may masquerade as a malware client 110 or 114 and/or as computer 108 or 112 via the one or more malware response messages. The one or more malware response messages may include a TCP reset command, a cryptographic key negotiation command, a cryptographic key negotiation message, a ZIP file or ZIP bomb, or some other payload.

The malware response module 124 may compare the one or more malware messages from the C2 server 120 to a set of known malware messages in a malware database to determine the one or more malware response messages to be sent to the malware C2 server 120. IDS 106 may be arranged to: i) detect malware communications between malware C2 server 120 and malware client 110 on computer 108 or malware client 114 on computer 112 and ii) send a malware alert to the malware response module 120.

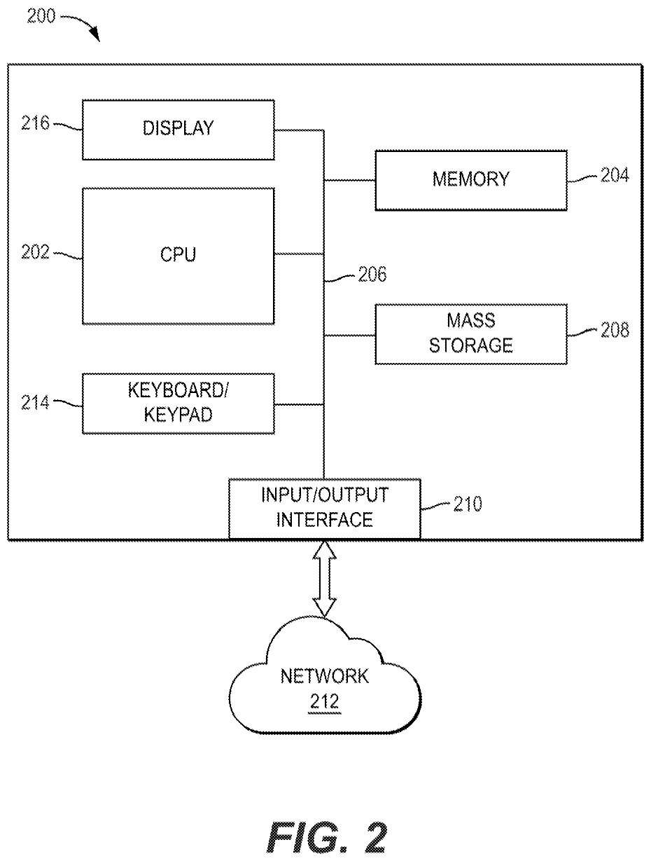

FIG. 2 shows a diagram of a computer system 200 arranged to perform functions associated with malware neutralization, including functions associated with malware response module 124. The computer system 200 may be implemented as a virtual machine or a physical machine. The exemplary computer system 200 includes a central processing unit (CPU) 202, a memory 204, and an interconnect bus 206. The CPU 202 may include a single microprocessor or a plurality of microprocessors or special purpose processors for configuring computer system 200 as a multi-processor system. The memory 204 illustratively includes a main memory and a read only memory. The computer 200 also includes the mass storage device 208 having, for example, various disk drives, tape drives, etc. The memory 204 also includes dynamic random access memory (DRAM) and high-speed cache memory. In operation, memory 204 stores at least portions of instructions and data for execution by the CPU 202. The memory 204 may also contain compute elements, such as Deep In-Memory Architectures (DIMA), wherein data is sent to memory and a function of the data (e.g., matrix vector multiplication) is read out by the CPU 202.

The mass storage 208 may include one or more magnetic disk, optical disk drives, and/or solid state memories, for storing data and instructions for use by the CPU 202. At least one component of the mass storage system 208, preferably in the form of a non-volatile disk drive, solid state, or tape drive, stores a database used for processing data and controlling functions of malware response module 124. The mass storage system 208 may also include one or more drives for various portable media, such as a floppy disk, flash drive, a compact disc read only memory (CD-ROM, DVD, CD-RW, and variants), memory stick, or an integrated circuit non-volatile memory adapter (i.e. PC-MCIA adapter) to input and output data and code to and from the computer system 200.

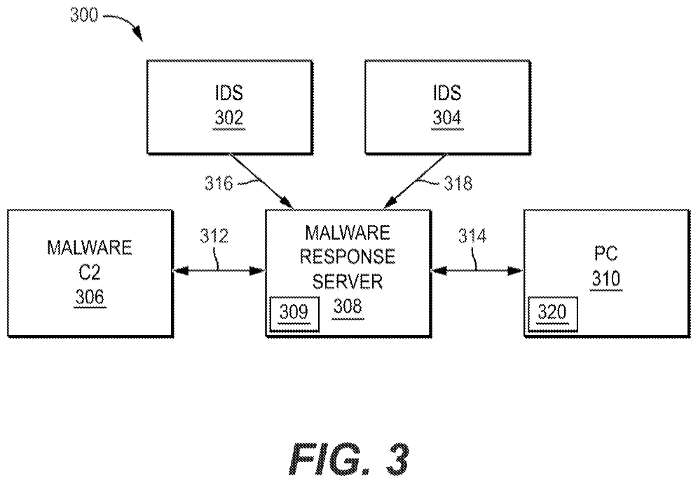

The computer system 200 may also include one or more input/output interfaces for communications, shown by way of example, as interface 210 and/or a transceiver for data communications via the network 212 and/or 118. The data interface 210 may be a modem, an Ethernet card or any other suitable data communications device. To provide the functions of a processor according to FIGS. 1 and 3, the data interface 210 may provide a relatively high-speed link to a network 212 and/or 118, such as an intranet, Internet, or the Internet, either directly or through another external interface. The communication link to the network 212 and/or 118 may be, for example, optical, wired, or wireless (e.g., via satellite or cellular network). The computer system 200 may also connect via the data interface 210 and network 212 to at least one other computer system to perform remote or distributed malware neutralization operations. Alternatively, the computer system 200 may include a mainframe or other type of host computer system capable of Web-based communications via the network 212. The computer system 200 may include software for operating a network application such as a web server and/or web client.

The computer system 200 may also include suitable input/output ports, that may interface with a portable data storage device, or use the interconnect bus 206 for interconnection with a local display 216 and keyboard 214 or the like serving as a local user interface for programming and/or data retrieval purposes. The display 216 may include a touch screen capability to enable users to interface with the system 200 by touching portions of the surface of the display 216. Server operations personnel may interact with the system 200 for controlling and/or programming the system from remote terminal devices via the network 212 and/or 118.

The computer system 200 may run a variety of application programs and store associated data in a database of mass storage system 208. One or more such applications may include a malware neutralization system according to FIGS. 1 and/or 3. The components contained in the computer system 200 may enable the computer system to be used as a server, workstation, personal computer, network terminal, mobile computing device. mobile telephone, System on a Chip (SoC), and the like. As discussed above, the computer system 200 may include one or more applications such as a response manage and/or module 124. The system 200 may include software and/or hardware that implements a web server application. The web server application may include software such as HTML, XML, WML, SGML, PHP (Hypertext Preprocessor), CGI, and like languages.

The foregoing features of the disclosure may be realized as a software component operating in the system 200 where the system 200 includes Unix workstation, a Windows workstation, a LINUX workstation, or other type of workstation. Other operation systems may be employed such as, without limitation, Windows, MAC OS, and LINUX. In some aspects, the software can optionally be implemented as a C language computer program, or a computer program written in any high level language including, without limitation, Javascript, Java, CSS, Python, Keras, TensorFlow, PHP, Ruby, C++, C, Shell, C#, Objective-C, Go, R, TeX, VimL, Peri, Scala, CoffeeScript, Emacs Lisp, Swift, Fortran, Visual BASIC, HDL, VHDL, and/or one or more versions of Verilog. Certain script-based programs may be employed such as XML, WML, PHP, and so on. The system 200 may use a digital signal processor (DSP).

As stated previously. the mass storage 208 may include a database. The database may be any suitable database system, including the commercially available or open source products, such as, but not limited to, Microsoft Access, Sybase, SQL Server, MongoDB, SqlLite. The database can be implemented as a local or distributed database system. The database may be supported by any suitable persistent data memory, such as a hard disk drive, RAID system, tape drive system, floppy diskette, or any other suitable system. The system 200 may include a database that is integrated with the system 100 or 300, however, it will be understood that, in other implementations, the database and mass storage 208 can be an external element. The database may include a malware detection database accessible by the malware response module 124 that is used to identify the type of malware threat and determine one or more response messages.

In certain implementations, the system 200 may include an Internet browser program and/or be configured to operate as a web server. In some configurations, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), and Transport Layer Security (TLS), for example. However, new protocols and revisions of existing protocols may be frequently introduced. Thus, in order to support a new or revised protocol, a new revision of the server and/or client application may be continuously developed and released.

In one implementation, the system 100 includes a networked-based, e.g., Internet-based, application that may be configured and run on any combination of the other components of the system 100. The computer system 200 may include a web server running a Web 2.0 application or the like. Web applications running on system 100 may use server-side dynamic content generation mechanisms such, without limitation, Java servlets, CGI, PHP, or ASP. In certain embodiments, mashed content may be generated by a web browser running, for example, client-side scripting including, without limitation, JavaScript and/or applets on a wireless device.

In certain implementations, system 100 may include applications that employ Verilog HDL, VHDL, asynchronous JavaScript+XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

The system 100, computer system 200, system 300, or another component of systems 100, 200, or 300 may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, 3DES, AES, RSA, ECC, and any like public key or private key based schemes.

FIG. 3 shows a block diagram of a malware neutralization system 300 including a malware response server 308, IDS 302, and IDS 304. The malware response module 309 can function as a man-in-the-middle with respect to communication channels 312 and 314 between a malware C2 server 306 and a malware host or client 320 operating within a personal computer (PC) 310. Malware response server 308 may be configured to receive malware alert messages from IDS 302 and 304 via communication channels 316 and 318 respectively. Although two IDSs 302 and 304 are shown, only a single IDS or any number of IDSs may communicate with malware response server 308. Malware response server 308 may be configured to recognize and/or process malware alerts of various formats to enable malware response server 308 to flexibly interface with and/or utilize information from different types of IDSs. As illustrated in FIG. 3, malware response module 309 may intercept communications between malware C2 server 306 and malware client 320 and, in the process, masquerade as the malware C2 server 306 to the malware client 320 and masquerade as the malware client 320 to the malware C2 server 306. This enables the malware response module 309 to, for example, negotiate encrypted sessions with both the malware C2 module 306 and the malware client 320 to, thereby, eavesdrop on communication between the malware G2 module 306 and malware client 320. This may also enable the response module 309 to insert and/or send disruptive messages to either or both the C2 server 306 and malware client 320 to shutdown and/or disrupt operations of either or both the C2 server 306 and malware client 320.

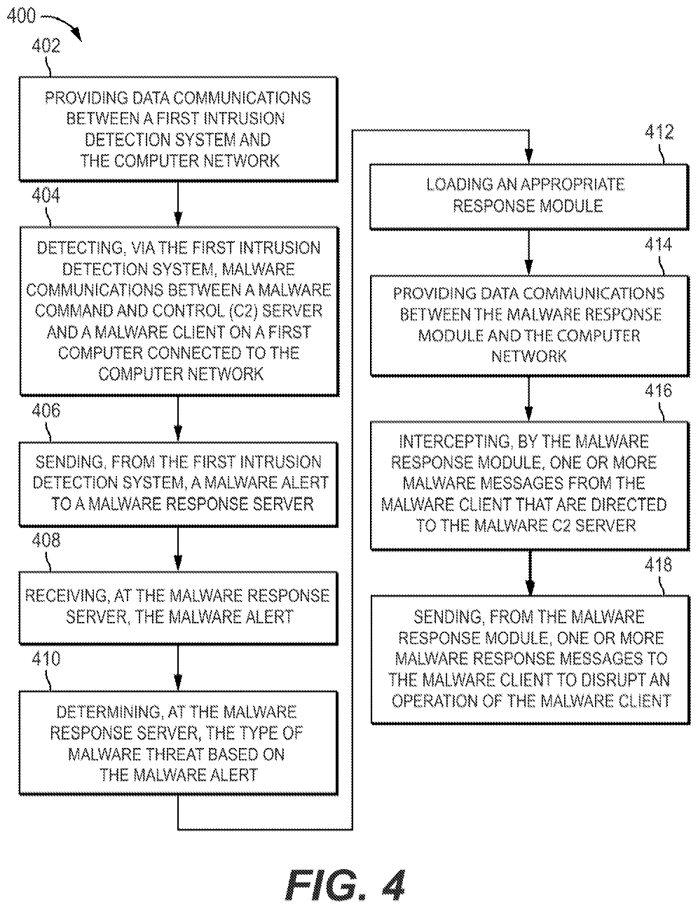

FIG. 4 shows a process 400 for neutralizing malware in a computer network. Process 400 includes: providing data communications between a first intrusion detection system, e.g., IDS 302 or 304, and the computer network 118 (Step 402); detecting, via the first intrusion detection system 302 or 304, malware communications between a malware command and control (C2) server 120 or 306 and a malware client 110 or 320 on a first computer 108 or 310 connected to the computer network 118 (Step 404); sending, from the first intrusion detection system 302 or 304, a malware alert to a malware response server 102 or 308 (Step 406); receiving, at the malware response server 102 or 308, the malware alert (Step 408); determining, at the malware response server 102 or 308, the type of malware threat based on the malware alert (Step 410): loading an appropriate response module (Step 412); providing data communications between the malware response module 124 or 308 and the computer network 118 (Step 414); intercepting, by the malware response module 124 or 309, one or more malware messages from the malware client that are directed to the malware C2 server 120 or 306 (Step 416); and sending, from the malware response module 124 or 309, one or more malware response messages to the malware client 110 or 320 to disrupt an operation of the malware client 110 or 320 (Step 418).

It will be apparent to those of ordinary skill in the art that certain aspects involved in the operation of the systems 100, 200, and 300, and other devices such as device or module 124 or 308 may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, SRAM or flash memory device having a computer readable program code stored thereon.

Elements or steps of different implementations described may be combined to form other implementations not specifically set forth previously. Elements or steps may be left out of the systems or processes described previously without adversely affecting their operation or the operation of the system in general. Furthermore, various separate elements or steps may be combined into one or more individual elements or steps to perform the functions described in this specification.

Other implementations not specifically described in this specification are also within the scope of the following claims.

What is claimed is:

1. A malware neutralization system for a computer network comprising:
a first intrusion detection system being in data communications with the computer network and arranged to: i) detect malware communications between a malware command and control (C2) server and a malware client on a first computer connected to the computer network and ii) send a first malware alert to a malware response server; and
the malware response server being in communications with the computer network and arranged to: i) receive the first malware alert, ii) determine the type of malware threat based on the first malware alert, iii) load an appropriate malware response module, iv) intercept one or more malware messages from the malware client that are directed to the malware C2 server, and v) send one or more malware response messages to the malware client to disrupt an operation of the malware client.

2. The system of claim 1. wherein the malware response module masquerades as the malware C2 server to the malware client.

3. The system of claim 2, wherein the malware response module masquerades as the C2 server to the malware client via the one or more malware response messages.

4. The system of claim 1, wherein the one or more malware response messages include at least one of a TCP reset command, a cryptographic key negotiation command, a cryptographic key negotiation message, a shutdown command, and other payload.

5. The system of claim 1, wherein the malware response module compares the one or more malware messages from the malware client to a set of known malware messages in a malware database to determine the one or more malware response messages to be sent to the malware client.

6. The system of claim 1, comprising a second intrusion detection system in communications with the computer network and arranged to: i) detect malware communications between a malware C2 server and the malware client on the first computer connected to the computer network and ii) send a second malware alert to the malware response server.

7. The system of claim 6, wherein the malware response server is arranged to: i) receive the second malware alert, ii) determine the type of malware threat based on the second malware alert, iii) load an appropriate malware response module, iv) intercept one or more malware second messages from the malware client that are directed to the malware C2 server, and v) send one or more second malware response messages to the malware client to disrupt an operation of the malware client.

8. A method for neutralizing malware in a computer network comprising:
providing data communications between a first intrusion detection system and the computer network;
detecting, via the first intrusion detection system, malware communications between a malware command and control (C2) server and a malware client on a first computer connected to the computer network:
sending, from the first intrusion detection system, a malware alert to a malware response server;
providing data communications between the malware response module and the computer network;
receiving, at the malware response server, the malware alert;
determining, at the malware response server, the type of malware threat based on the malware alert;
loading an appropriate malware response module;
intercepting, by the malware response module, one or more malware messages from the malware client that are directed to the malware C2 server; and
sending, from the malware response module, one or more malware response messages to the malware client to disrupt an operation of the malware client.

9. The method of claim 8 comprising masquerading, by the malware response module, as the malware C2 server to the malware client.

10. The method of claim 9, wherein the malware response module masquerades as the C2 server to the malware client via the one or more malware response messages.

11. The method of claim 8, wherein the one or more malware response messages include at least one of a TCP reset command, a cryptographic key negotiation command, a cryptographic key negotiation message, a shutdown command, and other payload.

12. The method of claim 8 comprising comparing, by the malware response module, the one or more malware messages from the malware client to a set of known malware messages in a malware database to determine the one or more malware response messages to be sent to the malware client.

13. The method of claim 8, comprising providing a second intrusion detection system in communications with the computer network being arranged to: i) detect malware communications between a malware C2 server and the malware client on the first computer connected to the computer network and ii) send a second malware alert to the malware response server.

14. The method of claim 13, wherein the malware response server is arranged to: i) receive the second malware alert, ii) determine the type of malware threat based on the second malware alert, iii) load an appropriate malware response module, iv) intercept one or more malware second messages from the malware client that are directed to the malware C2 server, and v) send one or more second malware response messages to the malware client to disrupt an operation of the malware client.

15. A non-transient computer readable medium containing program instructions for causing a computer to implement malware neutralization within a computer network comprising the method of:
receiving, from an intrusion detection system, a malware alert;
determining the type of malware threat based on the malware alert;
intercepting one or more malware messages from a malware command and control (C2) server that are directed to a malware client on a first computer connected to the computer network; and
sending one or more malware response messages to the malware client to disrupt an operation of the malware client.

16. The non-transient computer readable medium of claim 15 comprising masquerading, by the malware response module, as the malware C2 server to the malware client.

17. The non-transient computer readable medium of claim 16, wherein the malware response module masquerades as the C2 server to the malware client via the one or more malware response messages.

18. The non-transient computer readable medium of claim 15, wherein the one or more malware response messages include at least one of a TCP reset command, a cryptographic key negotiation command, a cryptographic key negotiation message, a shutdown command, and other payload.

19. The non-transient computer readable medium of claim 15 comprising comparing, by the malware response module, the one or more malware messages from the malware client to a set of known malware messages in a malware database to determine the one or more malware response messages to be sent to the malware client.

20. The non-transient computer readable medium of claim 15, comprising providing a second intrusion detection system in communications with the computer network being arranged to: i) detect malware communications between a malware C2 server and the malware client on the first computer connected to the computer network and ii) send a second malware alert to the malware response server.
